(19) United States
(12) Patent Application Publication
(10) Pub. No.: US 2012/0330520 A1
(43) Pub. Date: Dec. 27, 2012

(54) METHOD FOR CONTROLLING A GEARBOX BRAKE

(75) Inventor: Markus Ulbricht, Tettnang (DE)

(73) Assignee: ZF FRIEDRICHSHAFEN AG, Friedrichshafen (DE)

(21) Appl. No.: 13/581,332

(22) PCT Filed: Feb. 14, 2011
(86) PCT No.: PCT/EP2011/052087

§ 371 Date: Aug. 27, 2012

(30) Foreign Application Priority Data
Mar. 11, 2010 (DE) 10 2010 002 763.4

(51) Int. Cl. F16H 59/46; G06F 17/00

(52) U.S. Cl. 701/51

(57) ABSTRACT

A method of controlling a transmission brake of an automated manual transmission of countershaft design provided with claw clutches where the transmission brake is functionally connected, on the input side, with a transmission shaft and which can be actuated hydraulically or pneumatically by inlet and outlet valves, each being a 2/2-way magnetic pulse valve. When upshifting under load to a target gear, after the gear under load is disengaged, to synchronize the target gear, the inlet and outlet valve are controlled in such manner that, at the end of the disengagement process, the input speed reaches a predetermined synchronous speed. The magnetic pulse valves are controlled such that the duration of the synchronization process is harmonized and its quality is improved and at least the outlet valve is opened, in a controlled manner, as a function of the rotational speed difference between the transmission input and output speeds.

This application is a National Stage completion of PCT/EP2011/052087 filed Feb. 14, 2011, which claims priority from German patent application serial no. 10 2010 002 763.4 filed Mar. 11, 2010.

### FIELD OF THE INVENTION

The invention concerns a method for controlling a gearbox brake of an automated change-speed transmission of countershaft design and which is provided with claw clutches, the brake being functionally connected to an input-side transmission shaft and being actuated hydraulically or pneumatically by means of an inlet valve and an outlet valve, each in the form of a 2/2-way magnetic pulse valve, such that during an upshift from a gear under load to a target gear, when the load gear has been disengaged, to synchronize the target gear the inlet valve is first opened, and once a shifting speed has been reached the inlet valve is closed and, to disengage the transmission brake, the outlet valve is opened in such manner that at the end of the disengagement process the input speed reaches a predetermined synchronous speed.

### BACKGROUND OF THE INVENTION

A change-speed transmission of countershaft design intended for longitudinal mounting usually comprises an input shaft, at least one countershaft and an output shaft. The input shaft can be connected to and disconnected from the driveshaft of the drive motor by a motor clutch that acts as a starting and shifting clutch. The countershaft is arranged axis-parallel to the input shaft and is in permanent driving connection therewith by means of an input constant formed at least by a spur gear pair with fixed wheels arranged in a rotationally fixed manner on the respective transmission shafts (input shaft and countershaft). The output shaft is arranged to be axis-parallel to the countershaft and coaxial with the input shaft, and can be connected to the countershaft by way of a plurality of gear steps with different gear ratios. The gear steps are usually in the form of spur gear pairs, in each case with a fixed wheel arranged in a rotationally fixed manner on one transmission shaft (countershaft or output shaft) and a loose wheel mounted to rotate on the other transmission shaft (output shaft or countershaft). To engage a gear step, i.e. to produce a driving connection between the countershaft and the output shaft with the gear ratio of the gear step concerned, a gear clutch is associated with each loose wheel. The loose wheels of adjacent gear steps are usually arranged at least in pairs on the same transmission shaft, so that the gear clutches can correspondingly be combined in shifting packets each with a common shifting sleeve.

The shifting sequence of an upshift from a gear under load to a higher target gear generally begins when the torque delivered by the drive motor is reduced and at about the same time the motor clutch is opened, before the load gear is disengaged. Then the target gear is synchronized by reducing the input speed, i.e. the rotational speed of the input-side portion of the gear clutch of the target gear determined by the speed of the input shaft or of the countershaft, to the synchronous speed of the output-side portion of the gear clutch of the target gear determined by the speed of the output shaft. The target gear is then engaged and then, at about the same time, the motor clutch is closed and the torque delivered by the drive motor is increased again.

In automated transmissions the input speed is usually detected by a speed sensor arranged on the input shaft, whereas the output speed is detected by a speed sensor arranged on the output shaft. For the two speeds to be comparable it is necessary to relate them to a single transmission shaft, i.e. to convert them appropriately. However, since particularly with an arrangement of the loose wheels in alternating pairs on the countershaft and the output shaft it would be relatively complicated to convert the speeds in each case to the relevant transmission shaft with the gear clutch of the target gear concerned, it is usual to relate both speeds, in each case regardless of the arrangement of the loose wheel concerned, uniformly to the same transmission shaft, preferably the input shaft. For this it is only necessary to convert the output speed detected at the output shaft by multiplication with the gear ratio of the target gear and the gear ratio of the input constant, whereas the input speed detected at the input shaft can remain unchanged. Herein the conversion of the speeds, which is known per se, is not explicitly explained; rather, the input speed and the output speed are to be understood as the respective speeds already related to a common transmission shaft, in particular the input shaft.

In general unsynchronized gear clutches, called claw clutches, compared with gear clutches synchronized by means of friction rings and blocking teeth, have a much simpler structure, lower production costs, more compact dimensions, and are substantially less prone to wear and defects. In an automated transmission provided with claw clutches, during an upshift the target gear is preferably synchronized by means of a centrally arranged, controllable brake device such as a transmission brake that is functionally connected with the input shaft or the countershaft. Compared with the adjustment path dependent, adjustment speed and adjustment force variable control of a shifting mechanism for synchronizing and engaging a synchronized target gear, the control of a transmission brake and a shifting mechanism for synchronizing and engaging an unsynchronized target gear is relatively simple, since the sensor data from the speed sensors on the input shaft and the output shaft are essentially sufficient for this.

Current transmission designs of the AS-Tronic series, an automated change-speed transmission manufactured by the applicant for heavy goods vehicles, are in each case provided with a transmission brake arranged on one of the two countershafts present. This transmission brake is in the form of a disk brake and can be actuated pneumatically by means of a control valve made as a 3/2-way magnetic switching valve.

In its un-actuated rest position, the pressure chamber of the brake cylinder of the transmission brake is connected by way of the control valve to an unpressurized line that ends in a silencer. To synchronize the target gear in an upshift, the pressure chamber of the brake cylinder is connected by switching over or switching on the control valve to a pressure line carrying compressed air, whereby the transmission brake is activated and the countershaft concerned is braked.

During the braking of the countershaft, from the gradient of the input speed, the deactivation time or deactivation speed is calculated, at which by switching over or off the control valve the transmission brake is disengaged so that at the end of the disengagement process the input speed has largely reached the synchronous speed determined by the output speed. In this, a lag that is attributable to the response behavior of the transmission brake and the non-linear speed variation during the disengagement process are allowed for by a lead time. To eliminate the influence of pressure fluctuations in the pressure supply line, a pressure regulation valve is connected upstream from the control valve. Interfering factors such as operating temperature differences and varying friction coefficients of the disks are not directly detected in this type of control system, but are taken into account only indirectly by way of the speed gradients of the input speed, and are therefore compensated only inadequately. Accordingly, the target gear synchronization quality during upshifts therefore fluctuates markedly.

DE 196 52 916 B4 describes a corresponding transmission brake in the form of a disk brake, which can be actuated hydraulically or pneumatically and which is controlled by means of an inlet valve and an outlet valve. The inlet valve is connected on its input side to a pressure line and on its output side to the pressure chamber of the brake cylinder. The outlet valve is connected on its input side to the pressure chamber of the brake cylinder and on its output side to an unpressurized line. The two valves can optionally be in the form of 2/2-way magnetic switching valves or of 2/2-way magnetic pulse valves.

In DE 103 05 254 A1 and DE 103 30 517 A1 methods for controlling a transmission brake are indicated, which relate to a transmission brake according to DE 196 52 916 B4 with 2/2-way magnetic switching valves. In the method known from DE 103 05 254 A1 it is provided that during the upshift-related braking of the countershaft, the number of program cycles or the time until the synchronous speed is reached is calculated by means of a so-termed sum gradient which, as the difference between the gradients of the output speed and the input speed constitutes, as it were, an effective gradient. This takes into account that the synchronous speed determined by the output speed can increase or decrease, depending on the resultant driving resistance, during the shift-related traction force interruption.

In the method known from DE 103 30 517 A1 it is provided that the signal for deactivating the transmission brake is emitted a certain lead time before the synchronous time point determined has been reached, and the lead time is corrected, if necessary, as a function of the quality of the upshift concerned with regard to reaching the synchronous speed at the time when the gear clutch of the target gear is engaged. In this way the time for emitting the deactivation signal, i.e. for opening the outlet valve, is implicitly adapted globally to changed operating parameters such as an altered operating temperature.

In the aforesaid control sequences, interfering factors that occur in practice, such as pressure fluctuations in the pressure line of the pressure supply system, altered operating temperature and changed friction coefficients of the disks of the transmission brake, are compensated either by virtue of higher expenditure and complexity, for example by means of an upstream pressure regulation valve, or by a shift-quality-dependent correction of the lead time, or even not at all, which results in varying synchronization and upshift durations and in quality fluctuations of the synchronization and upshift processes.

### SUMMARY OF THE INVENTION

Thus, the purpose of the present invention is to indicate a method for controlling a transmission brake of the type mentioned earlier in an automated change-speed transmission of countershaft design provided with claw clutches, by virtue of which the control properties of the magnetic pulse valves provided in this case are utilized and the duration of the synchronization processes are harmonized and their quality is improved, with relatively little expenditure.

According to the invention this objective is achieved if at least the outlet valve is opened in a controlled manner as a function of the rotational speed difference between the input speed and the output speed.

Accordingly, the invention starts from a transmission brake, which is arranged in an automated change-speed transmission of countershaft design and provided with claw clutches, and which is functionally connected to an input-speed transmission shaft, i.e. the input shaft or a countershaft. Furthermore, the invention assumes that the transmission brake can be actuated hydraulically or pneumatically by means of an inlet valve and an outlet valve, each of them in the form of a 2/2-way magnetic pulse valve. For an upshift from a gear under load to a target gear, to synchronize the target gear, after the load gear has been disengaged the inlet valve is first opened. Once a shifting speed n_{U} has been reached the inlet valve is closed and to disengage the transmission brake the outlet valve is opened in such manner that the input speed n_{E} reaches a predetermined synchronous speed n_{Sync} at the end of the disengagement process (n_{E}=n_{Sync}).

Since at least the disengagement process, i.e. the degree to which the outlet valve is opened, is controlled as a function of the speed difference between the input speed and the output speed (Δn=n_{A}−n_{E}), the synchronous speed determined by the output speed (n_{Sync}=n_{A}) is reached with greater precision at the end of the disengagement process. During this a varying function of the braking torque of the transmission brake related to the wear condition of the friction linings or to an operating temperature change is automatically compensated by the control pressure p_{Br} present in the pressure chamber of the brake cylinder. Likewise, pressure fluctuations in the pressure line of the pressure supply system are compensated, so there is no need for a pressure regulating valve to be connected upstream from the two control valves. Regardless of the rotational speed interval to be bridged during the upshift concerned, the synchronization and shifting processes obtained are of almost equal duration, with a constant high quality.

Like the outlet valve, so too the inlet valve can be opened in a controlled manner as a function of the speed difference between the input and output speeds (Δn=n_{A}−n_{E}) until the shifting speed n_{U} is reached, i.e. operated with a variable degree of opening, whereby the engagement and braking phases of the transmission brake also take place with approximately constant quality and duration regardless of the rotational speed interval to be bridged and the influence of interfering factors.

In both variants the shifting speed n_{U} is preferably determined as a function of the speed difference (Δn=n_{A}−n_{E}) between the input speed (n_{E}) and the output speed (n_{A}). In an alternative, regulated variant the regulator used produces a control signal y which, as the speed difference Δn decreases (in the mathematical sense the value of Δn increases, since it is determined as Δn=n_{A}−n_{E} and therefore in the normal case assumes a negative value, which increases toward 0 as the speed difference decreases) follows a steady course from a maximum negative value yₘᵢₙ to a maximum positive value yₘₐₓ, such that the passage of the control signal through zero (y=0) determines the changeover between actuating the input valve and the output valve, and the numerical value of the negative control signal (|y|, y<0) is used for controlling the inlet valve whereas the positive control signal (y, y>0) is used for controlling the outlet valve.

However, it is also possible for the inlet valve to be opened to its maximum extent until the shifting speed n_{U} is reached. In this case the activation of the transmission brake and the braking of the input-side transmission shaft until the shifting speed is reached take place with the maximum control pressure p_{Br}, but then disturbances such as pressure fluctuations in the pressure line and changed disk friction coefficients remain uncompensated at first and can result in varying durations of the engagement and braking phases. However, advantages compared with a regulated engagement and braking phase of the transmission brake are: quicker slowing down of the input-side transmission shaft and the smaller control expenditure.

In this case it is expedient to determine the shifting speed n_{U} after the opening of the inlet valve has begun, in particular after a largely constant braking torque has been set and consequently a constant gradient of the input speed Δn_{E}/Δt has been obtained as a function at least of the current speed difference between the input and output speeds (Δn=n_{A}−n_{E}).

For this the shifting speed n_{U} can be calculated for example from the equation:

n_{U}=n_{E}+Δn−tᵥ*(Δn_{E}/Δt)

in which n_{E} is the current input speed, Δn is the current speed difference (Δn=n_{A}−n_{E}), (Δn_{E}/Δt) is the current gradient of the input speed (n_{E}) as a function of a constant pulse cycle T_{Z} (in particular Δt=n*T_{Z} with n=1, 2, 3, . . . ) and tᵥ is a lead time, for example to compensate a dead time (delay) attributable to the response behavior of the transmission brake.

The regulator used for controlling the inlet valve and the outlet valve or only for controlling the outlet valve is preferably in the form of a PD regulator, since this has advantages above all in relation to the regulation dynamics and overswing width.

The inlet and outlet valves can be operated with pulse width modulation (PWM). In this case the effective opening degree of the pulse valve concerned and thus the control pressure p_{Br} in the pressure chamber of the brake cylinder can be adjusted by varying the open time fraction (pulse width) T_{P} within a constant pulse cycle T_{Z}. However, this type of control has the disadvantage that according to experience, if the degree of opening is large, undefined floating conditions of the magnet armature pulse valve concerned can occur at the end of the pulse cycle, which have an adverse effect on the control dynamics and regulation ability.

For that reason the inlet and outlet valves are preferably operated with pulse frequency modulation (PFM). In this case the effective degree of opening of the pulse valve concerned and hence the control pressure in the pressure chamber of the brake cylinder is adjusted by varying the pulse cycle T_{Z} with a constant pulse width T_{P}. During this, at the end of every pulse cycle and having regard to a maximum valve dynamic, the magnet armature of the pulse valve always reaches the end position that corresponds to the closed rest position, which results in higher control dynamics and improved regulation ability.

### BRIEF DESCRIPTION OF THE DRAWINGS

To clarify the invention the description of drawings illustrating two example embodiments is attached. The drawings show:

FIG. 1: The signal flow diagram of a first variant of the method according to the invention,

FIG. 2: The signal flow diagram of a second variant of the method according to the invention,

FIG. 3: The rotational speed variations of the input and output speeds of a transmission during an upshift,

FIG. 4: The possible time variation of the control signal of a regulator for the first method variant according to FIG. 1,

FIGS. 5a, 5b, 5c: Various time variations of the control voltages of the control valves of the transmission brake shown in FIG. 6, and

FIG. 6: The structure of a transmission brake, shown in schematic form.

### DETAILED DESCRIPTION OF THE PREFERRED EMBODIMENTS

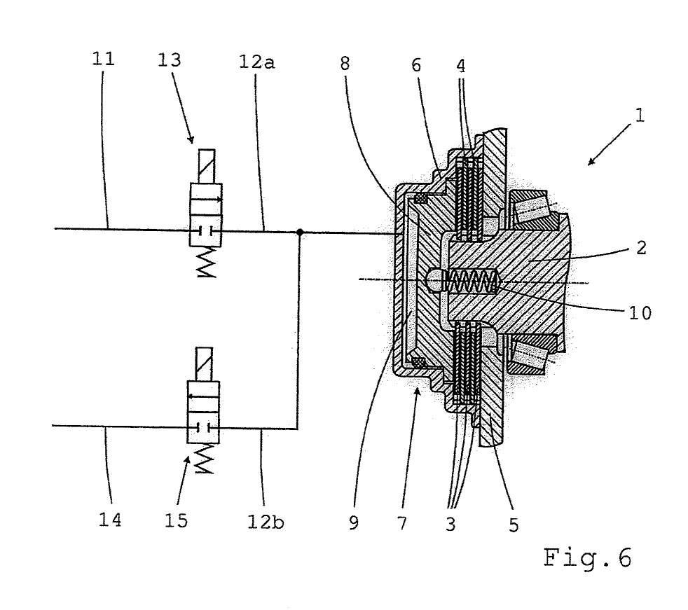

FIG. 6 shows a typical transmission brake 1 of an automated change-speed transmission of countershaft design provided with claw clutches, with which the control method according to the invention can be used. The transmission brake 1 is in the form of a hydraulically or pneumatically actuated disk brake and is in this case arranged at the engine-side end of a countershaft 2 of the transmission (no more of which is shown). The inner and outer disks 3, 4 of the transmission brake 1 are connected in a rotationally fixed manner, in alternation to the countershaft 2 and to a brake housing 6 mounted on an end wall 5 of the transmission housing 5 on the engine side.

The transmission brake 1 is actuated by a piston 8 which is arranged to move axially in a brake cylinder 7 and is acted upon axially on the outside by the controllable control pressure p_{Br} in the pressure chamber 9 of the brake cylinder 7, by which it is pushed toward the disks 3, 4 in opposition to the restoring force of a spring 10 arranged between the piston 8 and the countershaft 2.

The control pressure p_{Br} acting in the pressure chamber 9 is controlled by means of an inlet valve 13, which is connected on the input side to a pressure line 11 carrying the pressure medium being used and on the output side to the pressure chamber 9 by way of a connecting line 12a, and by means of an outlet valve 15 connected on its input side by way of a connecting line 12b to the pressure chamber 9 and on its output side to an unpressurized line 14 that leads to an oil sump or a silencer. The two valves 13, 15 are each in the form of a 2/2-way magnetic pulse valve that can be operated with pulse width modulation (PWM) or pulse frequency modulation (PFM), and which, in the unactuated, i.e. non-energized rest position, are either closed or open. Preferably the outlet valve 15 is designed as a Normally-Open valve, i.e. when not energized it is open, in order to prevent the persistence of residual torques caused by incomplete venting of the pressure chamber 9.

An upshift of the transmission from a gear under load to a higher, target gear begins with a load reduction of the drive motor connected upstream from the input side of the transmission, and the approximately simultaneous opening of an engine clutch arranged between the driveshaft of the drive motor and the input shaft of the transmission. After this, the target gear is synchronized by braking the countershaft 2 by means of the transmission brake 1.

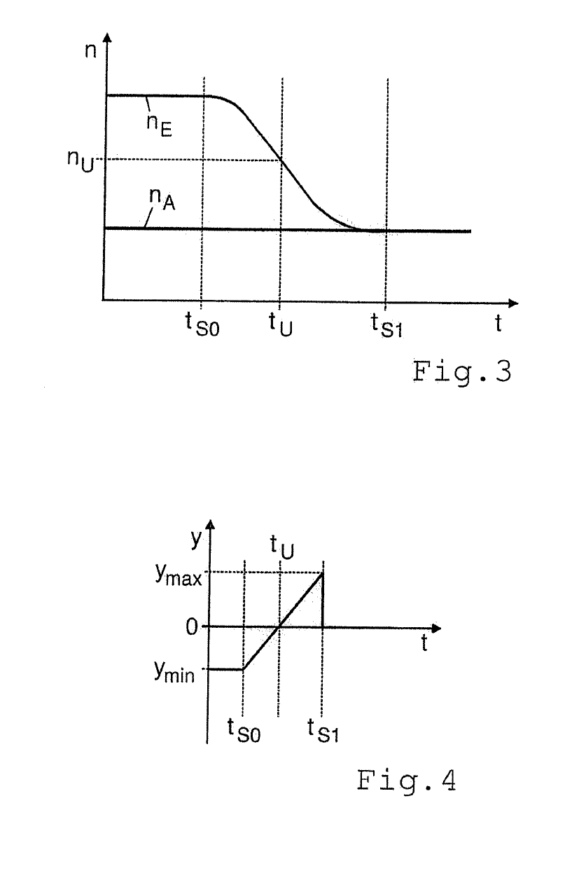

Examples of the corresponding time variations of the input speed n_{E} and the output speed n_{A}, in each case referred to the input shaft of the transmission, are shown in FIG. 3, where the output speed n_{A} is taken to be substantially constant.

As shown in FIG. 3, synchronization of the target gear begins at time t_{S0} with the opening of the inlet valve 13, so that after the pre-filling of the pressure chamber 9 of the brake cylinder 7 a substantially constant braking torque M_{Br} of the transmission brake 1 and consequently a substantially constant gradient Δn_{E}/Δt of the input speed is produced. When a shifting time point t_{U} and a shifting speed n_{U} are reached, which have to be determined appropriately, the inlet valve 13 is closed and by opening the outlet valve 15 in a controlled manner the control pressure p_{Br} in the pressure chamber 9 is reduced and the transmission brake 1 is thereby disengaged. The disengagement process ends at a time t_{S1}, when the input speed n_{E} reaches the synchronous speed n_{Sync} determined by the output speed n_{A}. After this the gear clutch of the target gear is engaged and at approximately the same time the engine clutch is closed and the torque delivered by the drive motor is increased again.

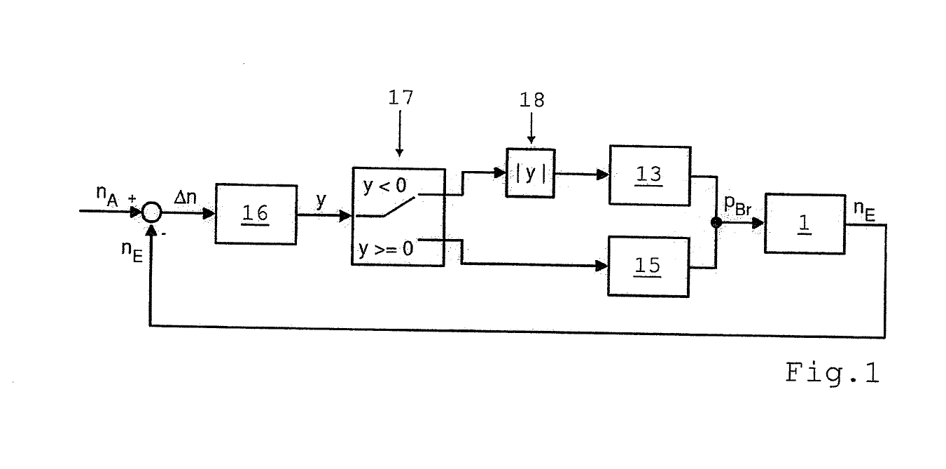

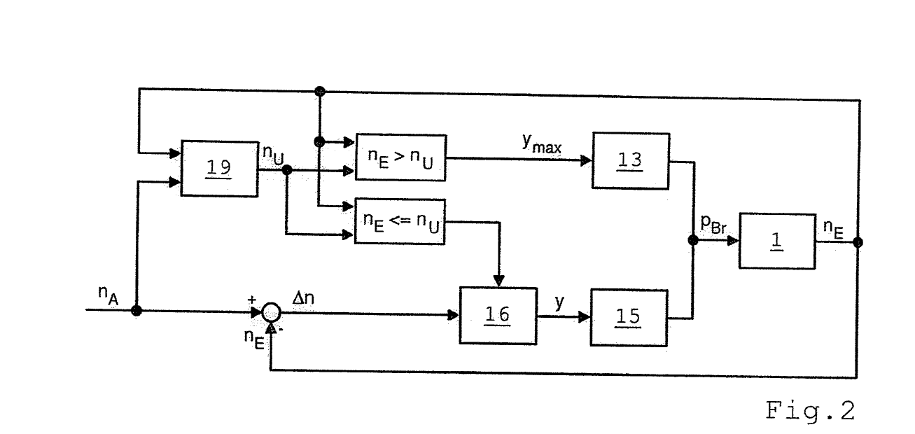

The mode of operation of the method according to the invention for controlling the transmission brake 1 between the times t_{S0}and t_{S1} is indicated by the signal flow diagrams shown in FIGS. 1 and 2.

In a first variant of the method, shown in FIG. 1, throughout the interval from t_{S0} to t_{S1} the transmission brake 1 is operated in a regulated manner, namely in the interval from t_{S0} to t_{U} by regulated actuation of the inlet valve 13 and in the interval from t_{U} to t_{S1} by regulated actuation of the outlet valve 15. For this, the regulating difference Δn consisting of the difference between the input speed n_{E} and the output speed n_{A}, which is to be minimized by the synchronization, is transmitted to a regulator 16 preferably in the form of a PD regulator, which from this derives and emits the control signal y.

In this case the regulator 16 produces a control signal y which, as the speed difference Δn decreases (as already explained the value of Δn during this increases in a mathematical sense, since Δn is determined as Δn=n_{A}−n_{E} and therefore normally has a negative value which increases toward zero as the speed difference decreases), the signal y varying in a steady manner from a negative maximum value yₘᵢₙ to a positive maximum yₘₐₓ, such that the zero-transition (y=0) of the control signal determines the change between actuating the inlet valve 13 and actuating the outlet valve 15. Thus, in this first method variant the shifting time point t_{U} and shifting speed n_{U} are also determined in a regulated manner. A corresponding time variation of the control signal y during a synchronization process and between the values yₘᵢₙ and yₘₐₓ is shown as an example in FIG. 4.

The switching block 17 connected downstream from the regulator 16 in FIG. 1 symbolizes the switching logic which, when the control signal is negative (y<0), transmits its numerical value (see block 18) to the inlet valve 13 or its control device and, when the control signal is positive (y>=0), transmits it to the outlet valve 15 or its control device. By means of the respective control valve 13, 15 the control pressure p_{Br} present in the pressure chamber 7 of the brake cylinder 9 is varied in such manner that the regulating or pressure difference Δn is brought toward zero in a controlled manner.

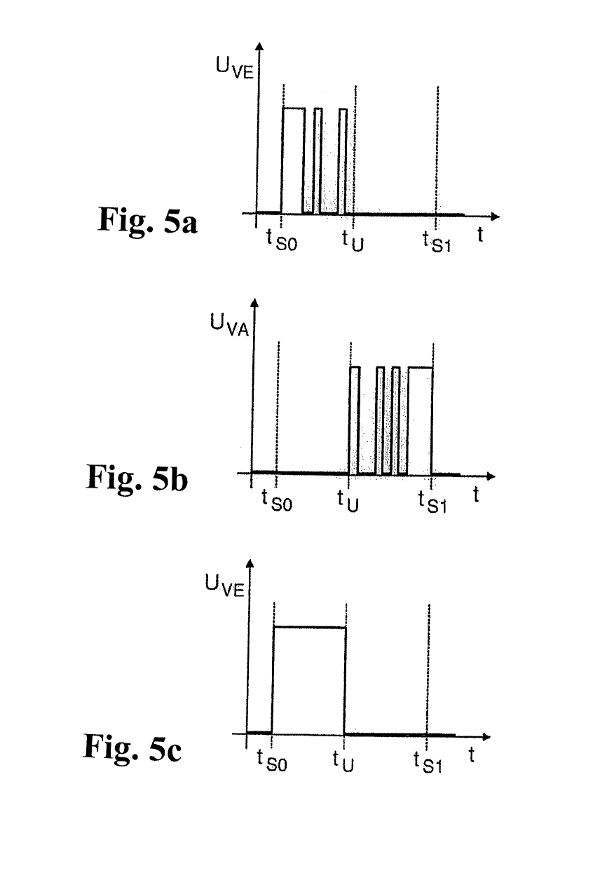

For pulse width modulation (PWM) or pulse frequency modulation (PFM) of the control valves 13 and 15, examples of corresponding time variations of the control voltage U_{VE}, U_{VA} of the inlet valve 13 and of the outlet valve 15 are shown respectively in FIGS. 5a and 5b. By virtue of the regulated operation of the control valves 13, 15, possible disturbing influences such as pressure fluctuations in the pressure line 11 and a different operating behavior of the transmission brake 1, for example caused by an operating temperature change or by changed friction coefficients of the disks 3, 4, are compensated automatically. Likewise, regardless of the speed difference to be bridged and of possible disturbing influences, largely reproducible synchronization sequences with almost the same duration are obtained.

In a second method variant according to FIG. 2, the transmission brake is controlled until the switching time point t_{U} on the switching speed n_{U} is reached, i.e. during the interval from t_{S0} to t_{U}, and only thereafter operated in a regulated manner until the synchronous speed n_{Sync} is reached at time point t_{S1}.

For this, after the opening of the inlet valve 13 begins, in particular after the setting of a substantially constant braking torque M_{Br}, the switching speed n_{U} is determined at least as a function of the current input speed n_{E} and the current output speed n_{A}, or the current speed difference Δn (Δn=n_{A}−n_{E}, see calculation block 19). Until the switching speed n_{U} is reached, i.e. during the interval from t_{S0} to t_{U}, the inlet valve 13 is for example held at its maximum degree of opening (yₘₐₓ), as illustrated in FIG. 5c for a pulse width modulated inlet valve 13 with reference to the time variation of the control voltage U_{VE}. Alternatively to the time variation of the control voltage U_{VE} shown in FIG. 5c, the inlet valve 13 can also be actuated with a predefined, constant PWM or PFM signal, i.e. opened in a controlled manner until the switching speed n_{U} is reached. When the switching speed n_{U} is reached the inlet valve 13 is switched off, i.e. closed, and then, analogously to the first method variant, the outlet valve 15 is operated by opening it in a regulated manner until the synchronous speed n_{Sync} is reached at time t_{S1}.

Compared with the first method variant, the second method variant has the advantages that the control of the inlet valve 13 is technically simpler and the braking operation, until the switching speed n_{U} is reached, is shorter.

### Indexes

1 Transmission brake
2 Countershaft, transmission shaft
3 Inner disks
4 Outer disks
5 End wall
6 Brake housing
7 Brake cylinder

### 8 Piston

9 Pressure chamber

### 10 Spring

11 Pressure line
12a, 12b Connecting line
13 Inlet valve
14 Unpressurized line
15 Outlet valve

### 16 Regulator

17 Switching block
18 Numerical value block
19 Calculation block

### M Torque

M_{Br} Braking torque
n Rotational speed
n_{A} Output speed
n_{E} Input speed
n_{Sync} Synchronous speed
n_{U} Shifting speed

### p Pressure

p_{Br} Braking pressure, control pressure in the brake cylinder 7

### PFM Pulse Frequency Modulation

### PWM Pulse Width Modulation

t Time, time point
t_{S0} Start of synchronization
t_{S1} End of synchronization
t_{U} Shifting time
U Electric voltage
U_{VA} Control voltage of the outlet valve 15
U_{VE} Control voltage of the inlet valve 13
y Control signal
yₘₐₓ Maximum value of the control signal y
yₘᵢₙ Negative maximum value of the control signal y
Δn Rotational speed difference
Δn_{E}/Δt Rotational speed gradient of the input speed (n_{E}) as a function of a constant cycle time (T_{Z})

1-11. (canceled)

12. A method of controlling a transmission brake (1) of an automated change-speed transmission of countershaft design provided with claw clutches, the transmission brake (1) being functionally connected on an input side with a transmission shaft (2) and being actuated either hydraulically or pneumatically by an inlet valve (13) and an outlet valve (15), each of the inlet valve (13) and the outlet valve (15) being a 2/2-way magnetic pulse valve, the method comprising the steps of:
controlling the transmission brake such that for an upshift from a gear under load to a target gear, after disengaging the gear under load, first opening the inlet valve (13) to synchronize the target gear when a switching rotational speed (n_{U}) is reached, closing the inlet valve (13) and opening the outlet valve (15) to disengage the transmission brake (1) such that, at an end of the disengagement process, an input rotational speed (n_{E}) reaches a predetermined synchronous speed (n_{Sync}) (n_{E}=n_{Sync}),
at least opening the outlet valve (15) in a controlled manner as a function of the rotational speed difference (Δn=n_{A}−n_{E}) between the input rotational speed (n_{E}) and an output rotational speed (n_{A}).

13. The method according to claim 12, further comprising the step of opening the inlet valve (13) in a controlled manner as a function of the rotational speed difference (Δn=n_{A}−n_{E}) between the input rotational speed (n_{E}) and an output rotational speed (n_{A}) until the switching rotational speed (n_{U}) is reached.

14. The method according to claim 12, further comprising the step of determining the switching rotational speed (n_{U}), in a controlled manner, as a function of the rotational speed difference (Δn=n_{A}−n_{E}) between the input rotational speed (n_{E}) and the output rotational speed (n_{A}),
producing, via a regulator, a control signal (y) which, as the rotational speed difference (Δn=n_{A}−n_{E}) decreases, varies steadily from a maximum negative value (yₘᵢₙ) to a maximum positive value (yₘₐₓ) such that passage of the control signal through zero (y=0) determines switching over between actuating the inlet valve (13) and actuating the outlet valve (15), and using a numerical value of a negative control signal (|y|, y<0) for controlling the inlet valve (13) and using a positive control signal (y, y>0) for controlling the outlet valve (15).

15. The method according to claim 12, further comprising the step of opening the inlet valve (13) either to a maximum extent or in a controlled manner with either a predefined and constant (PWM or PFM) signal until the switching rotational speed (n_{U}) is reached.

16. The method according to claim 12, further comprising the step of after commencing opening of the inlet valve (13) and after a substantially constant braking torque is set, determining the switching rotational speed (n_{U}) as a function of at least a current rotational speed difference (Δn=n_{A}−n_{E}) between the input rotational speed (n_{E}) and the output rotational speed (n_{A}).

17. The method according to claim 16, further comprising the step of calculating the switching rotational speed (n_{U}) as a function of the current rotational speed difference (Δn=n_{A}−n_{E}) and a current gradient (Δn_{E}/Δt) of the input rotational speed, which depends on a constant pulse cycle (T_{Z}).

18. The method according to claim 17, further comprising the step of calculating the switching rotational speed (nₒ) by the equation:
n_{U}=n_{E}+Δn−t_{V}*(Δn_{E}/Δt)
in which n_{E} is the current input rotational speed,
Δn is the current rotational speed difference (Δn=n_{A}−n_{E}),
(Δn_{E}/Δt) is the current gradient of the input rotational speed as a function of a constant pulse cycle (T_{Z}), and
t_{V} is a lead time.

19. The method according to claim 14, further comprising the step of using a regulator (16) in the form of a PD regulator for either controlling both the inlet valve (13) and the outlet valve (15) or controlling only the outlet valve (15).

20. The method according to claim 12, further comprising the step of operating the inlet valve (13) and the outlet valve (15) with pulse width modulation (PWM).

21. The method according to claim 12, further comprising the step of operating the inlet valve (13) and the outlet valve (15) with pulse frequency modulation (PFM).

22. The method according to claim 12, further comprising the step of utilizing a normally open valve as the outlet valve (15).

23. A method of controlling a transmission brake of an automated manual transmission during an upshift from a gear under load to a target gear, the automated manual transmission having a countershaft design and comprising claw clutches, the transmission brake being functionally connected to an input side of a transmission shaft and is actuatable either hydraulically or pneumatically by an inlet valve and an outlet valve, each of the inlet valve (13) and the outlet valve (15) being a 2/2-way magnetic pulse valve, the method comprising the steps of:
initiating an upshift from a gear under load to a target gear;
disengaging the gear under load;
synchronizing the target gear by opening the inlet valve (13) until a switching rotational speed (n_{U}) is reached and, thereafter, closing the inlet valve (13) and opening the outlet valve (15) to disengage the transmission brake (1); and
controlling disengagement of the transmission brake (1) by opening the outlet valve (15) as a function of a rotational speed difference (Δn=n_{A}−n_{E}) between an input rotational speed (n_{E}) and an rotational output speed (n_{A}) such that the input speed (n_{E}) is equal to a predetermined synchronous speed (n_{Sync}) at an end of the disengagement of the transmission brake (1).
